(19) United States
(12) Patent Application Publication
(10) Pub. No.: US 2002/0194140 A1
(43) Pub. Date: Dec. 19, 2002

(54) Metered access to content

(76) Inventor: Keith Makuck, Apex, NC (US)

Correspondence Address: COATS & BENNETT, PLLC, P O BOX 5, RALEIGH, NC, 27602, US

(21) Appl. No.: 09/837,531

(22) Filed: Apr. 18, 2001

(51) Int. Cl. H04L 9/00; H04K 1/00; G06F 17/60

(52) U.S. Cl. 705/67

(57) ABSTRACT

A user requesting premium content from a content provider is redirected to a service provider with which the user may have or may create an account. The account is funded with block purchases of sufficient size to justify credit card transaction costs. The service provider then stores a random user ID and password in the content provider's secure authorized user database. The user is redirected to the content provider with the random user ID and password prepended to the redirection URL. The service provider tracks how long the user accesses the premium content and charges the user's account the time multiplied by the rate. Periodically, the service provider pays the content provider based on the charges users have incurred accessing the premium content.

### BACKGROUND OF THE INVENTION

1. Field of the Invention

The present application relates to providing Internet content to either local or

2. Description of the Related Art

The Internet explosion has been well documented in both the press and the courtroom. The business-to-consumer model that was initially popular has seen some of the most visible disappointments due to a desire to grab audience members without a coherent plan for profitability, but even the business-to-business model is experiencing the crunch of the contemporary economic slowdown. Of course, other reasons also exist for why some Internet companies fail. Companies that remain and are still using the Internet are struggling with ways to make money with their Internet presence. Banner advertising, click through tracking, and the like have all been attempted, but to date none has proven to be a reliable income generator for the participants.

Many of the most successful sites, perhaps ironically in light of the “free” nature of the Internet, are those that charge for access to their content. A few models exist in this context, with some sites using more than one concurrently. A first model is a flat fee per time period arrangement, wherein the content provider charges a flat periodic fee and allows the user to access the content whenever the user desires. This usually involves a login and password protocol, but may also be facilitated through the use of cookies. A second model is metered access, wherein the user establishes an account with a service provider and that account is decremented based on the amount of time during which the content was accessed. Alternatively, a monthly bill is generated and sent to the user. Contemporary examples abound. WESTLAW and LEXIS use both flat fee and metered arrangements, with bills to the user sent after the fact. Many adult sites use flat fees.

The aforementioned services tend to attract repeat customers who frequently access the content. There, however, does exist a class of content that may not generate such repeat traffic. For this class of content, the average user may be unwilling to pay a multi-dollar fee for a month's worth of access, when they really only need to view the content for an hour or so. Charging the user a palatable amount, typically cents or tens of cents, historically does not make sense from a transaction cost point of view. This is especially true since one of the primary currency forms on the Internet is a credit card. Credit card companies charge between 0.5 and 5 percent of the amount of the transaction depending on volume. Such a surcharge on a ten cent transaction cripples the ability of the vendor to make money on such transactions.

Thus, there remains a need for vendors to collect viable income from what are sometimes termed micropayments.

### SUMMARY OF THE INVENTION

The present invention allows content providers to have micropayments without incurring crippling transaction fees or developing a technology to support it. A user requesting premium content from a content provider is redirected to a service provider with which the user may have or may create an account. The account is funded with block purchases of sufficient size to justify credit card transaction costs. The service provider then stores a random user ID and password in the content provider's secure authorized user database for one session. The user is redirected to the content provider with the random user ID and password prepended to the redirection URL. The service provider tracks how long the user accesses the premium content and charges the user's account the time multiplied by the rate. The service provider removes the random user ID and password from the content provider's secure authorized user database upon completion of the usage by the user. Periodically, the service provider pays the content provider based on the charges users have incurred accessing the premium content.

### BRIEF DESCRIPTION OF THE DRAWINGS

FIG. 1 illustrates a schematic drawing of a network such as may use the present invention;

FIG. 2 illustrates a block diagram of an exemplary computer such as may be used by a user of the present invention;

FIG. 3 illustrates a block diagram of an exemplary embodiment of the software used in the present invention;

FIG. 4 illustrates a block diagram of an exemplary embodiment of the software installed on the service provider computer as used in the present invention;

FIG. 5 illustrates a block diagram of an exemplary software module used on the service provider computer;

FIG. 6 illustrates a block diagram of an exemplary embodiment of the software installed on the content provider computer as used in the present invention;

FIGS. 7A and 7B illustrate a flow chart diagram of one embodiment of the login methodology of the present invention;

FIG. 8 illustrates a flow chart diagram of one embodiment of new user account creation procedures;

FIG. 9 illustrates a flow chart diagram of one embodiment of the communication between the authorization module and the authentication module;

FIGS. 10A and 10B illustrate a flow chart diagram of one embodiment of polling module's function during a session;

FIGS. 11A and 11B illustrate a flow chart diagram of one embodiment of the accounting module procedures;

FIG. 12 illustrates a flow chart diagram of one embodiment of the logout function; and

FIG. 13 illustrates a flow chart diagram of one embodiment of the audit function.

### DETAILED DESCRIPTION

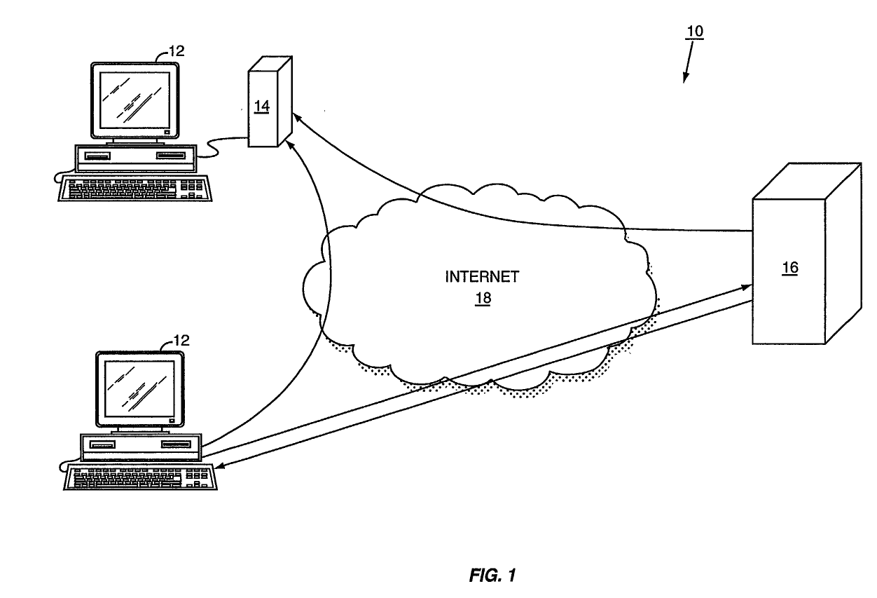

It is contemplated that the present invention will be implemented on a network of computers such as that indicated generally at 10 in FIG. 1. Network 10 comprises at least one user computer 12 accessible by a user, at least one content provider computer 14, and a service provider computer 16. These computers 12, 14, and 16 are connected via a communication network, such as the Internet 18.

A “computer” is defined herein as any data processing device including a microprocessor, such as conventional personal computers, personal digital assistants, mobile terminals, and the like. The term is meant to be construed broadly.

Also, the term “current_time” is used numerous times in the discussion of the software of the present invention. “current_time” is the value of the current date and time based on NTP from the atomic clock expressed in UNIX epoch time. This value is always determined at the service provider computer 16.

While it is possible that content provider computer 14 may be accessed directly by a user through a conventional input/output interface such as a keyboard, monitor, and mouse, such is not expected. This situation may occur, for example, when a user visits the physical location or store wherein content provider computer 14 is located, and the user attempts to access content.

Alternatively, a user may use user computer 12 with a direct dial-in access such as over a modem. The user may instruct his computer 12 to call the content provider computer 14 and provide appropriate log in information or other desired access information to establish a connection as is well understood.

Finally, a user may connect the user computer 12 to the content provider computer 14 through the Internet 18, using an Internet Service Provider, such as BELLSOUTH.NET™, GTE.NET™, or the like. Specifically contemplated would be accessing the World Wide Web with a web browser and, from there, accessing a web page hosted by the content provider computer 14. Within this last category of user are also those users who support their own Internet gateway, such as those individuals having their own Internet server, domain name, and the like.

While the Internet 18 is contemplated as the network by which communication between computers 12, 14, 16 is accomplished, other networks, proprietary or public could equivalently be substituted. Additionally, there are numerous networks, both satellite and terrestrial that may be combined to create such a network. Such subsidiary networks could comprise a cellular network, a telephone network, a cable network, or the like. The physical network connection for the computers 12, 14, 16 could be wired connections, such as telephone lines, digital subscriber lines, TV cables, fiber-optic links, and so on, and/or wireless connections, such as microwave, cellular, radio, satellite links and the like. It is worth mentioning that Internet 18, in its present incarnation, incorporates most, if not all, of these connections and networks.

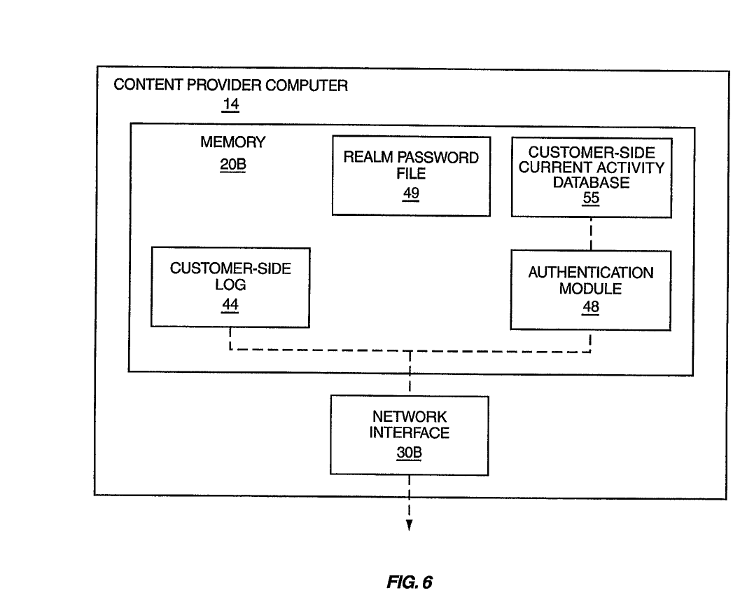

Content provider computer 14 may include conventional memory (not shown explicitly) in which content is stored. This content may be text, graphics, video, audio, or the like and is, in most embodiments, copyrighted material the content provider has created and for which access thereto the content provider wishes to be compensated. Alternatively, in some embodiments, the content may be uncopyrightable database material assembled through much effort and for which access thereto the content provider wishes to be compensated. Further content provider computer 14 may have a software module adapted for use with the present invention stored in the memory 20B (FIG. 6).

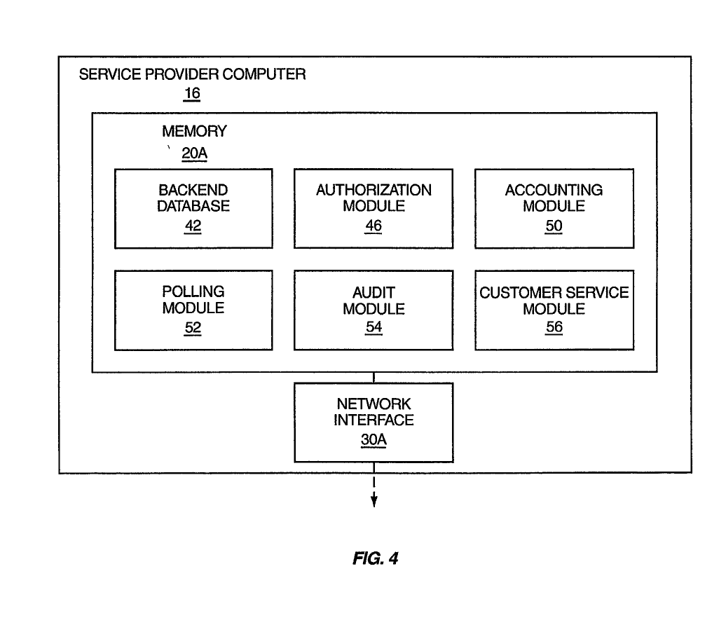

Service provider computer 16 may also comprise memory 20A (FIG. 4), having software adapted for use with the present invention stored therein. Both the software in service provider computer 16 and content provider computer 14 may be written in any appropriate code as needed or desired.

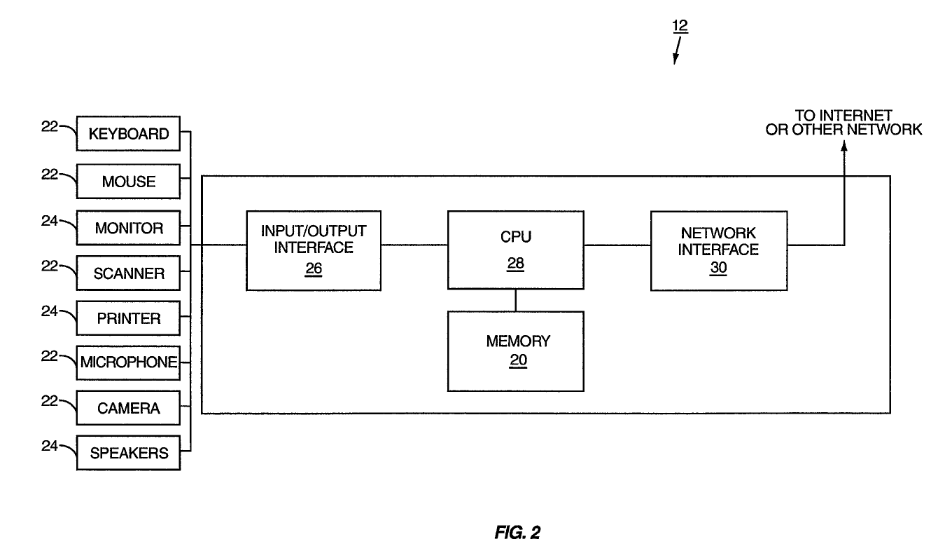

FIG. 2 illustrates a more detailed version of the user computer 12. It should be appreciated that content provider computer 14 and service provider computer 16 may be substantially similar. User computer 12 comprises input devices 22, output devices 24, an input/output interface 26, a central processing unit (CPU) 28, a network interface 30, and memory 20. Input devices 22 and output devices 24 may be various and sundry including, but not limited to, a keyboard, a mouse, a joystick, track ball, electronic stylus, a scanner, a microphone, speakers, a camera (video or still), a display or monitor, a printer, or the like. CPU 28 may be a single processor or a plurality of processors. Examples of appropriate processors include those manufactured by INTEL™, Advanced Micro Devices, Inc., Motorola, Inc., or Sun Microsystems. Network interface 30 could be a telephone modem, a cable modem, a DSL modem, a wireless modem, or the like to connect the user computer 12 to the Internet 18 or other network.

Memory 20 may be read/write memory. Appropriate memory may be selected from the list including, but not limited to: flash memory, EEPROM, hard drive, CD-ROM, optical CD, floppy disk, DVD-ROM, magnetic tape, or other form of computer memory as is well understood in the field of computers. It should be appreciated that the structure of the computer 12 is provided as an example and is not intended to be limiting.

It is specifically contemplated that the content provider computer 14 and service provider computer 16 both generally similar to computer 12 may be connected to the Internet 18 at all times and therefore should be adapted to have a fail safe and hot-swappable structure. This will allow continued operation even in the event of isolated failures within the system. Additionally, it is specifically contemplated that the computers 14, 16 will be backed-up regularly as is well known in the industry in the event of the need to recover from a catastrophic failure.

While the computers 12, 14, 16 have been described as centralized computers, each at one physical location, those skilled in the art will appreciate that the computers 12, 14, 16 could use other architectures to accomplish the same functionality. In another embodiment, each computer 12, 14, 16 could be a distributed system with multiple computer systems, each of them similar to the computer 12 shown in FIG. 2, at one physical location and linked together through a local area network (LAN). Each of the computer systems performs part of the tasks in a centralized computer system. In yet another embodiment, each computer 12, 14, 16 could be a distributed system with multiple computer systems scattered across a number of physical locations but linked together through a wide area network (WAN). Each of the computer systems may also perform only one part of tasks of a centralized computer system.

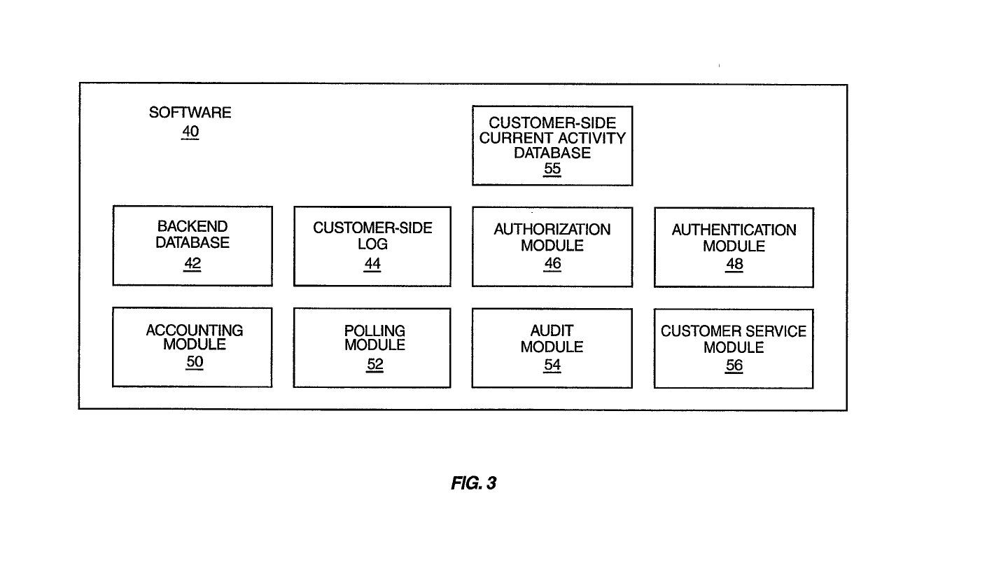

It is contemplated that the present invention will be embodied in software, illustrated in block format in FIG. 3, and noted generally by numeral 40. Note that while it is contemplated that software is the most economical way to implement the present invention, enterprising individuals may also embody the functionality of the present invention in dedicated circuitry that performs identically without the need for software per se. Such alternate structures are still within the scope of the present invention.

Software 40 may comprise a backend database 42, a customer-side log 44, an authorization module 46, an authentication module 48, an accounting module 50, a polling module 52, an audit module 54, a customer side current activity database 55, and a customer service module 56. Some of these modules are resident in the content provider computer 14 and some are resident in the service provider computer 16.

For example, as illustrated in FIG. 4, service provider computer 16 may include memory 20A with the backend database 42, the authorization module 46, the accounting module 50, the polling module 52, the audit module 54, and the customer service module 56 stored thereon. These modules may use the network interface 30A as needed or desired to communicate with the modules in the content provider computer 14, described below with reference to FIG. 6.

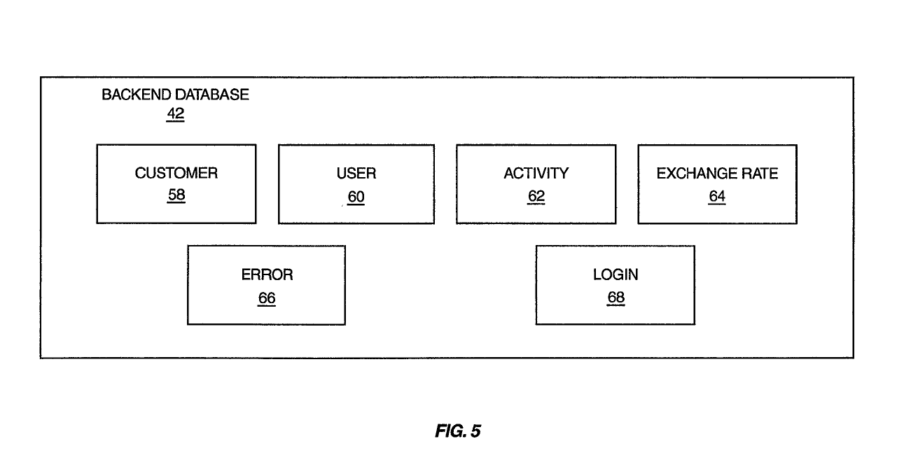

Backend database 42, better illustrated in FIG. 5, comprises a customer database 58, a user database 60, an activity log database 62, an exchange rate database 64, an error log database 66, and a login database 68. “Customer,” in this context, refers to the content provider, while the term “user” denotes the visitors to the content providers' sites.

Customer database 58 contains the information necessary to provide accurate statistics and payment to customers (content providers). In one embodiment, this comprises the following information, presented in tabular form.

TABLE 1

| Data | Type | Reference |
|---|---|---|
| Account Number | Text | CA |
| Name of Company | Text | CB |
| Contact at Company | Text | CC |
| Authorized User ID | Text | CD |
| Authorized Password | Text | CE |
| Postal Address | Text | CF |
| Phone Number | Text | CG |
| Contact email address | Text | CH |
| Service provider commission rate | Number | CI |
| Browsing initial rate | Number | CJ |
| Browsing rate per minute | Number | CK |
| Browsing rate/minute breakaway | Number | CL |
| Breakaway | Number | CM |
| Browsing rate initial (schedule) | Number | CN |
| Browsing rate/minute (schedule) | Number | CO |
| Browsing rate/minute breakaway | Number | CP |
| (schedule) | | |
| Schedule begin | Date/Time | CQ |
| Schedule end | Date/Time | CR |
| Revenue since last check in bits (running | Number | CS |
| total) | | |
| Revenue since last check in dollars | Number | CT |
| (running total) | | |
| Profit since last check in dollars (running | Number | CU |
| total) | | |
| Amount of last cut check | Number | CV |
| Date of last cut check | Date/Time | CW |
| Activity Log | Relational | CX |
| Redirect URL (Premium content area) | Text | CY |
| Adult | Boolean (yes/no) | CZ |
| Cobranded Page Login | HTML | CZ1 |
| Cobranded Page New User | HTML | CZ2 |
| Number of Referrals | Number | CZ3 |
| Administratively Up/Down | Boolean | CZ4 |
| Address of Authentication Module | Text | CZ5 |
| Authentication Module Security Key | Hex | CZ6 |
| Last Audit | Timestamp | CZ7 |
| Last Contact | Timestamp | CZ8 |

The variables whose purpose is not readily ascertainable are discussed below. The commission rate may vary between customers (content providers), depending on the contract terms in place between the content providers and the service provider. This variable represents the commission that the service provider receives for transactions it handles for the content providers.

In one embodiment, rates and balances will be in a fictional currency called “bits.” Each bit may be equivalent to a fraction of a cent. In one embodiment, a bit is a tenth of a cent. Other denominations are also possible.

Browsing rate initial comprises the rate a site may set that will bill the user immediately upon visiting the customer's site (hosted on the content provider computer 14). It is possible that this value may be set to zero.

Browsing rate per minute is the rate that a user is billed until they reach the “breakaway,” should the breakaway value be set. The breakaway value will be expressed in minutes and represents an amount of time at which a user's rate changes from one rate to another. In many embodiments, the subsequent rate is lower.

Browsing rate per minute breakaway is the new rate a user is to be charged after the breakaway time is reached. All of the rates that include (schedule) are variables that are needed to implement a rate scheduling feature. The purpose of this feature is to allow customers to schedule promotional rates that begin and end at predetermined times. Likewise, some content providers may charge peak rates during periods of heavy usage. This can be implemented with the schedule feature.

The Revenue Since Last Check in Bits is added to by the Accounting module 50. The Revenue Since Last Check in Dollars is a mathematical function (CS*EA) (EA is explained later). The Profit Since Last Check in Dollars is a mathematical function (CT*(1−CI)).

The customer activity log (the logins to their site) are available relationally in the Activity database 62.

The Redirect URL is the Uniform Resource Locator (URL) that the authorization module 46 uses to send the user to the content provider's member's only or premium content web space.

The Adult tag specifies whether or not users under eighteen should be allowed access to the site.

The Cobranded Page Login/New User HTML pages allow customers to setup a login screen on the service provider computer 16 that contain the customers' logos, trademarks, or other style sheets to allow for a more seamless user experience.

The Number of Referrals is a running count of the number of new service provider users referred by the particular content provider. This number may be used for promotional purposes.

The Administratively Up/Down tag is a Boolean value that will prevent users from trying to login to a customer site, should the customer want to disallow access temporarily. Alternatively, this may be flagged down when the service provider computer 16 detects that the content provider computer 14 is not operative. This may occur when an Internet connection is lost; the server is being maintained; or for other reasons.

The Address of Authentication Module tells the Authorization Module 46 where the Authentication Module 48 is located on the content provider computer 14 as addressed by a URL or the equivalent.

The Authentication Module Security Key is a string that will be used to match and verify that the request for changes to the customer's secure password realm 49 (FIG. 6) are indeed coming from the service provider computer 16 and are not spoofed. This value is only viewable and editable by the service provider's staff. The key is unique to each customer and embedded in the Authentication Module 48 binary code given to the customer (content provider).

The Last Audit is the date and time of the last audit commanded of the authentication module 48 by the audit module 54. In one embodiment, audits are run approximately every five hours. Similarly, the Last Contact is the last date and time that the audit module 48 was able to contact the authentication module 48. In one embodiment, this contact may be instigated every three minutes.

The User database 60 may contain the data necessary to provide the ability to monitor, add, and withdraw funds. In one embodiment, this comprises the following information, presented in tabular form.

TABLE 2

| Data | Type | Reference |
|---|---|---|
| Account Number | Text | UA |
| Name of User | Text | UB |
| Authorized User ID | Text | UC |
| Authorized Password | Text | UD |
| Password Challenge Answer | Text | UE |
| Adult Restriction | Boolean (allow/deny) | UF |
| Credit Card Number (optional) | Number | UG |
| (secure) | | |
| Balance available for spending | Number | UH |
| Balance available for cash out | Number | UI |
| Activity Log | Relational | UJ |
| Auto logout Pref | Boolean (yes/no) | UK |
| Auto logout time | Number | UL |
| Show user status window pref | Boolean (yes/no) | UM |
| Privacy pref | Boolean (yes/no) | UN |
| Promotional email pref | Boolean (yes/no) | UO |
| User email address | Text | UP |
| Allow Compromised Account | Boolean (yes/no) | UQ |

Again, the variables whose utility is not immediately apparent is presented below. The Password Challenge Answer may be the user's answer to a personal question. (E.g., what is your mother's maiden name; in what town were you born; what is the name of your pet). This allows the user to recover a forgotten password via email or other acceptable alternative.

The Adult Restriction variable exists for the purpose of allowing a parent to setup an account for a minor child that will disallow this user's access to sites that are marked with the Adult variable (CY) of yes in the customer database 58. This variable may not be edited by the user after the initial setup of the account. The default value, in one embodiment, is to allow the access. It is also possible that this may be a birthdate, and all users under 18 years of age are disallowed from adult sites as indicated by the Adult variable.

The Credit Card Number allows the user to store his/her credit card on file to purchase more “bits” without having to reenter the card number. This number may not be stored in the user database 60. Rather, the number may be stored in a secure database on a firewalled machine that allows one way communication only if desired.

The Balance available for spending is the variable that may be decremented with visits to content providers. This variable may be incremented with credit card purchases to the account, promotional offers, and customer service adjustments.

The Balance available cash out may be decremented with visits and incremented only with credit card purchases or customer service adjustments. In one embodiment, an automatic promotion may allow users to get bonus bits depending on how much they deposit into the account initially. These bonus bits will be added to the balance available for spending variable only, and not to the Balance available cash out. This prevents people from turning a promotion into cash.

At any time, a user will have the ability to request that the service provider convert their Balance available cash out back into cash. This may be posted as a credit to their credit cards, a check, or other equivalent means. Note that both the Balance available cash out and the Balance available for spending are both decremented at the same time, which means that the balance available for spending will always be equal to or larger than the balance available for cash. In one embodiment, a service provider staff member must approve a cash out transaction to protect against fraud.

The activity log is available to user relationally from the activity log database 62.

The auto logout pref is a feature that prevents a user from being billed for more time than they intended by forgetting to logout. The auto logout time is a value in minutes that reflects the amount of time since login to the customer site that a user session will automatically expire. In one embodiment, the default value for auto logout pref is no.

The show user status window pref allows a user to determine whether or not they would like a floating window with their status to appear while browsing. This floating window, a “user status window”, is another feature that prevents users from being billed for time that they did not use by recording hits every sixty seconds for updates, safeguarding against crashed computers, disconnected phone lines, and the like. The accounting module 50 uses this value to determine whether or not to logoff a user that has lost contact with the service provider computer 16. In one embodiment, the default value is set to yes. If the user chooses not to see the user status window and chooses not to use auto-logout, the user runs the risk of running their account to zero should they forget to logout of a site or if their machine crashes in the middle of a login session. While this may be economically attractive to the service provider, the provision of these features is considered an acceptable customer service compromise.

The privacy pref is the implementation of a feature that allows user to go to customer sites with no record of the visit by the service provider. Under the circumstances where the privacy pref is off, the username, account number, date and time of login/logout, user's IP address and site visited are all kept in the activity log database 62 (See Table 3 below). Activity log 62 contains the user's information for the purpose of customer service adjustments of account balance for disputed claims. If the privacy pref is on, the history of the activity log shows “PRIVATE” in place of account number, username, and IP address, which will cause the relational activity log database 62 to not associate the user with any activity. Users may be warned that use of this feature limits their ability to receive refunds or credits for disputed visits to sites, since there is no audit trail to follow. In one embodiment, the default value is set to no.

The promotional email pref is a feature that determines whether or not the user will be sent mass mailings from the service provider or its partners.

The allow compromised account is a value that can only be changed by customer service. This feature allows the user's accounts to be accessed by multiple Class A subnets within a predefined time period. A Class A subnet is a way of describing a block of Internet addresses as is well understood by those in the industry. A more detailed explanation may be located at www.zdwebopedia.com/TERM/I/IP_address.html.

The activity log database 62 contains information necessary to allow accounting of all visits and logins so that funds may be debited and credited properly from the user accounts to the customer accounts. In one embodiment, this comprises the following information, presented in tabular form.

TABLE 3

| Data | Type | Reference |
|---|---|---|
| Date/Time of Open | Timestamp | AA |
| Date/Time of Close | Timestamp | AB |
| IP Address | Text | AC |
| User Account Number | Text | AD |
| Customer Account Number | Text | AE |
| Privacy | Boolean | AF |
| Accounted | Boolean | AG |
| User Status Window Open | Boolean | AH |
| Last Poll Received | Timestamp | AI |
| AM User ID/Pass Pair | Text | AJ |
| Spent | Number | AK |
| Current Rate | Number | AL |
| Prev. Time | Timestamp | AM |
| Session Number | Number | AN |
| Audited Open | Boolean | AO |
| Audited Close | Boolean | AP |

Again, the variables whose utility is not immediately apparent is presented below. The Date/Time of Open and the Date/Time of Close represent the login and logout times from a customer site respectively. If the Date/Time of Close is empty, the user is still logged into a customer site. If the user is using the auto-logout feature, the Date/Time of Close may be set to a time that has not yet arrived.

The IP Address is the IP address of the user computer 12. Its only intended purpose is for logging and the detection of a compromised user account. Other uses may be possible of course.

The Privacy value is the determination of whether or not the IP address and user account Number will be removed from the database upon completion of the open session.

The Accounted value is used by the accounting module 50 to determine whether or not the user and customer balances were debited/credited for the activity.

The User Module Open value is set by the polling module 52 and checked by the accounting module 50. The value is determined by the Show User Status Window Prefin the user database 60.

The Last Poll Received value is set by the polling module 52 and checked by the accounting module 50.

The AM User ID/Pass Pair is the user ID and password that has been added to the customer's password realm 49 that is allowing this session's access to the content provider computer 14. It exists in the activity log database 62 so that when the session is over, the authorization module 46 knows what user/password to kill, preventing further access to the customer's site. This also exists so that user can get back onto the content provider computer 14 should the user's browser crash midsession.

The Spent variable is the number of bits spent by this user so far during this particular session. The accounting module 50 calculates and updates this figure. It is used to determine whether or not a user has spent more than exists in their account. It is also used for updating the user and customer databases 60 and 58 with account debits/credits at the end of the session. Spent is also displayed in the user's status window during a new session.

The Current Rate is the cost per minute of the session at that moment. This number may change during the user's session depending on the breakaway values set by the customer. The accounting module 50 calculates this value and uses it to help determine Spent.

The Prev Time is the last time the accounting module 50 touched and modified the record. It may be used to determine Spent based on Current Rate. An exemplary equation is: AK=AK+((current_time−AM)*AL).

The Session Number is a unique sequential identifier for the record. It is used by the authorization module 46 to ensure that kill orders are not being spoofed.

The Audit Open and Audit Close variables may be defaulted to no, and are set to yes by the audit module 54. It is used to identify activity that was never performed by the authentication module 48.

The login database 68 may comprise the information necessary to provide a record of user and customer logins to the service provider computer 16 for the purpose of security. In one embodiment, this comprises the following information, presented in tabular form.

TABLE 4

| Data | Type | Reference |
|---|---|---|
| Date/Time | Timestamp | LA |
| IP Address | Text | LB |
| Account Number | Text | LC |
| Successful | Boolean | LD |

These variables are essentially self-explanatory.

The exchange rate database 64 may comprise the information necessary to convert a user's bits available for spending from dollars. In one embodiment, this comprises the following information, presented in tabular form.

TABLE 5

| Data | Type | Reference |
|---|---|---|
| Base rate per dollar | Number | EA |
| Breakaway 1 | Number | EB |
| Breakaway 1 bonus amount | Number | EC |
| Breakaway 2 | Number | ED |
| Breakaway 2 bonus amount | Number | EE |
| Breakaway 3 | Number | EF |
| Breakaway 3 bonus amount | Number | EG |
| Breakaway 4 | Number | EH |
| Breakaway 4 bonus amount | Number | EI |

These rates may be used for promotions or the like. The Base rate per dollar in one embodiment never changes, and is the conversion factor for dollars to bits and vice versa. In one embodiment, a dollar is one thousand bits. The Breakaway numbers represent optional promotional thresholds. For example, if a user spends $20, an extra five hundred bits may be awarded to the user. Note, the promotional bits may be available for spending, but not for cash back, as alluded to earlier. In one embodiment, the breakaway bonuses are cumulative.

The error log database 66 contains all errors dumped from any of the running modules. In one embodiment, this comprises the following information, presented in tabular form.

TABLE 6

| Data | Type | Reference |
|---|---|---|
| Date/Time of Error | Timestamp | RA |
| Date/Time Logged | Timestamp | RB |
| Error | Text | RC |
| Error Arguments | Text | RD |

These variables are essentially self-explanatory.

Authorization module 46 runs on the service provider computer 16 and is triggered by hits on its URL. Authorization module 46 communicates directly with the backend database 42, authentication module 48, accounting module 50, polling module 52, and customer service module 56. In one embodiment, authorization module 46 handles:

user login, including safeguards against compromised accounts and entry into login database 68;

creation of randomized AM User ID and password;

submission to the activity log database 62 of “open” and “close”;

secure communication of “open” and “close” AM User ID and password to the authentication module 48;

forwarding of user to customer redirect URLs with AM User ID and password prepended;

spawning of user status windows by sending the user to a predetermined URL with a browser cookie set that identifies the user; and

receipt of kill orders from the accounting module 50 and the polling module 52.

Accounting module 50 also runs on the service provider computer 16. Nothing triggers this module per se, rather, in an exemplary embodiment, it runs continuously in a loop. Accounting module 50 communicates with the backend database 42, authorization module 46, and the polling module 52. In one embodiment, accounting module 50 handles:

determination of open sessions through queries of the activity log database 62;

determination of whether the site is administratively up or down;

determination of closed sessions through queries of the activity log database 62;

determination and adjustment of current rate in the activity log database 62;

calculation and update of the amount a user has spent in a given session;

sending kill orders to the authorization module 46 if the user has spent all of their available balance for spending;

sending kill orders to the authorization module 46 if there is no response from the user status window in five minutes (assuming that the window is open);

adjustments to user and customer balances; and

changing the accounted value in the activity log database 62 to true.

Polling module 52 also runs on the service provider computer 16 and may be triggered by hits on a predetermined URL. Polling module 52 communicates with backend database 42 and authorization module 46. In one embodiment, polling module 52 handles:

verification of a user's identity by reading a cookie or requesting login;

creation of user status window, containing user's current browsing information, gleaned from activity log database 62 (Company name, browsing rate initial, browsing rate/minute, date/time of open, date/time of close, spent, privacy, auto logout pref, and auto logout time).

setting User module open to true;

calculation/display of bits left by comparing User Balance Available for spending with Spent;

ability to restart the Auto Logout time timer by changing of the Date/Time of Close in activity log database 62 only if Date/Time of Close is later than the current time, else return an error to the user;

display link of the redirect URL with AM User ID and password prepended;

display logout button that triggers kill order to authorization module 46;

generation of javascript for user status window that detects if user status window is closed; and

trigger of user confirmation and setting of user module open equals false upon confirmation.

Audit module 54 also runs on service provider computer 16 and is triggered by the accounting module 50. Audit module 54 communicates with the backend database 42 and authentication module 48. In one embodiment, audit module 54 handles:

request of audit information from authentication module 48;

sending any errors reported by authentication module 48 to error log database 66;

comparing “open” and “close” entries in the customer-side log 44 with entries in activity log database 62, logging discrepancies in error log database 66;

checks reachability of the remote site;

changing audit open and audit close entries in activity log database 62 to yes; and

logging any missing customer-side log 44 information in error log database 66.

Customer side current activity database 55 may be used to see if the site at the content provider is currently up. In essence, the authentication module 48 looks to see if it has heard from the service provider computer 16 for a length of time. If no communication has been received within the threshold, then the content provider computer 14 may prune out the currently “active” users as indicated by this database. The service provider computer 16 may do the same.

Customer service module 56 also runs on service provider computer 16. Customer service module 56 is triggered by hits on a predetermined URL. Customer service module 56 communicates with backend database 42 and authorization module 46. In one embodiment, customer service module 56 handles:

addition and deletion of user accounts on the service provider computer 16;

addition of funds to a user account;

credit card transactions; and

display and changes to user preferences and/or data.

As noted, these software elements interface with those software elements present on the content provider computer 14. Content provider computer 14 may include memory 20B with customer-side log 44 and authentication module 48 stored therein, as illustrated in FIG. 6. Additionally, a secure password realm 49 may exist. This password realm 49 includes user ID's and password pairs for each authorized user of the premium content available on the content provider computer 14. This may be a simple file, a complete database, or other data structure as needed or desired. Customer-side log 44 and authentication module 48 communicate through network interface 30B as needed.

Customer-side log 44 is created and read by the authentication module 48. In one embodiment, it exists for the purpose of audits. In one embodiment, this comprises the following information, presented in tabular form.

TABLE 7

| Data | Type | Reference |
|---|---|---|
| Date/Time | Timestamp | GA |
| Command | Text | GB |
| AM User/Pass | Text | GC |

The Date/Time is the date and time that the Authentication module 48 added or removed the AM User/Pass in the customer's password realm 49 for the secure realm. This timestamp is based on the time conveyed by the Authorization module 46 in its command, not the timestamp from the content provider computer 14.

The Command may be ADD, DEL, AUTO_DEL, ERROR_DUP, ERROR_KEY, ERROR_IP, ERROR_NO, or AUD. This represents the command received by the authentication module 48 or an error as a result of a command. ERROR_DUP is a duplicate User ID found in the customer's password realm 49 that prevents a new one from being added. ERROR_KEY is a bad security key calculation in the command. ERROR_IP is an attempted communication by a machine with an IP address that is not in the allowed access list of addresses. ERROR_NO is a removal request of a User ID and password that does not exist in the customer's password realm 49. AUTO_DEL are user ID and password pairs deleted by the authentication module 48 without being commanded to do so by the authorization module 46. This may be the result of lost communication with the audit module 54.

The AM User/Pass is the User ID and password added or removed in the customer's secure password realm 49. In the event of AUD, the field may be empty. In the event of ERROR_DUP or ERROR_NO, it will contain the User ID and password that resulted in the error. In the event of ERROR_IP or ERROR_KEY, it will contain the IP address of the machine that communicated the bad key or attempted an unauthorized communication.

Authentication module 48 listens on a TCP port for connections. It communicates directly with the authorization module 46, audit module 54, customer-side log 44, the existing secure password realm 49 on the content provider computer 14, and the customer side current activity database 55. In one embodiment, the function of the authentication module 48 is to handle:

secure receipt of “open” and “close” AM User ID and password commands;

addition and removal of “open” and “close” AM User ID and password to/from the existing secure password realm 49 on the content provider computer 14;

removing AM User ID and password items in the customer side current activity database 55 after no communication from the audit module 54 after a specified period of time;

creation of a log file on the content provider computer 14 of all transactions; and

sending audit information to the audit module 54 upon request.

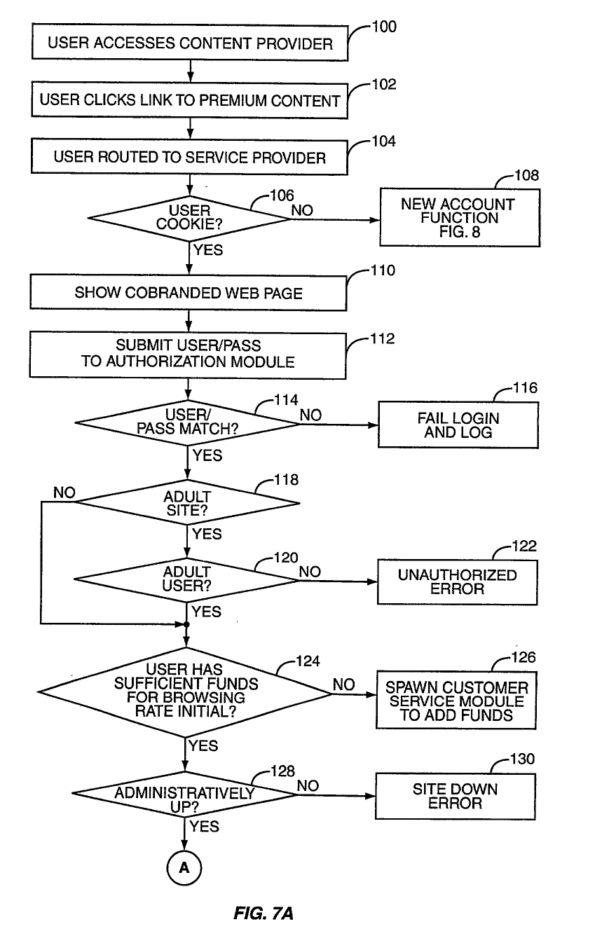

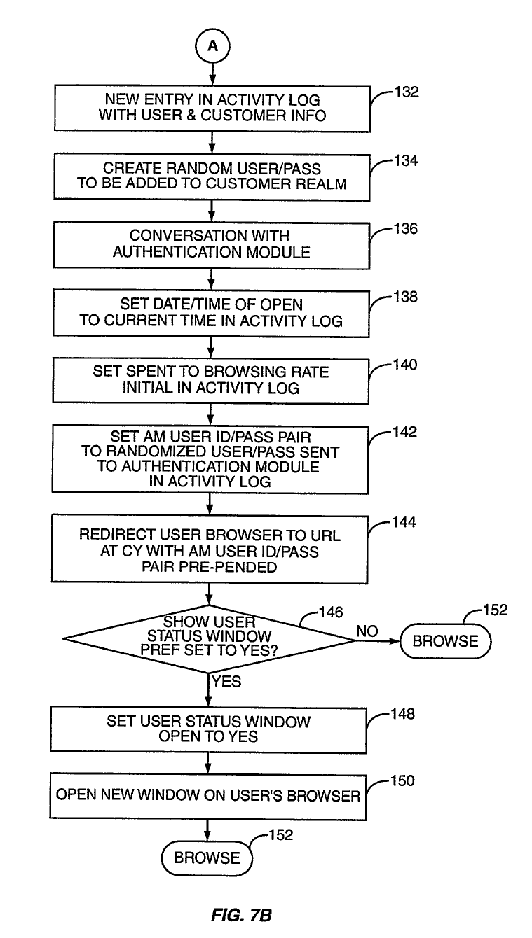

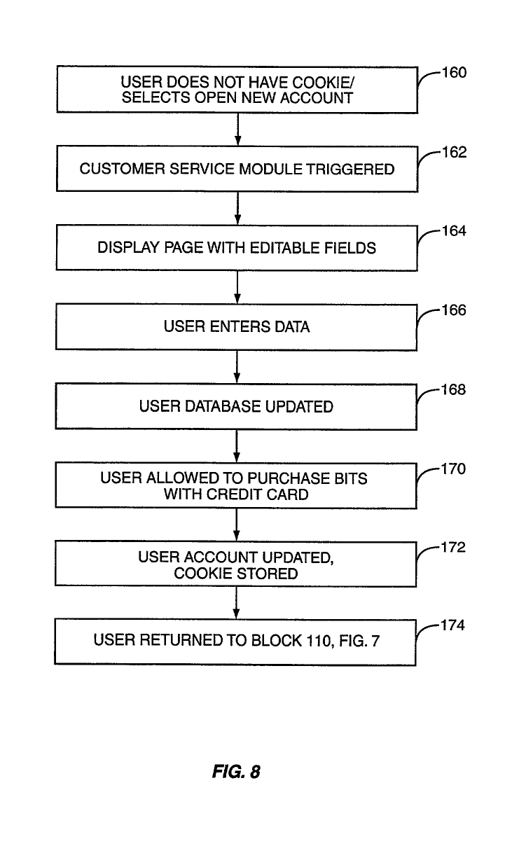

Against this backdrop of software 40, it may be helpful to explore a sample session of metered access on a content provider computer 14. An exemplary login session is illustrated in FIG. 7. A user, using user computer 12, accesses content provider computer 14 and specifically a web page thereon (block 100). That web page contains links to content, including some premium content stored in a secure realm of memory 20B. The user clicks on a link to premium content (block 102). This causes the content provider computer 14 to redirect the user to the service provider computer 16 (block 104). The user is redirected with information about from where the user was redirected. E.g., CA from table 1. It should be appreciated that access to the content is not necessarily exclusive through the service provider. The content provider may still provide access to users through other means. In short, it is possible that the present invention may piggyback on the methodology that the content user has previously adopted or subsequently adopts. Service provider computer 16, specifically authorization module 46, checks for a cookie on the user's browser (block 106). The cookie represents the existence of an account with the service provider. If block 106 is answered negatively, i.e., there is no cookie, then a new account function routine is launched (block 108). This is explicated with respect to FIG. 8 below.

If block 106 is answered positively, i.e., there is a cookie, then the authorization module 46 launches a cobranded web page (CZ1 from table 1) associated with the referring customer as indicated by CA (block 110). The cobranded web page may contain a User ID field, with the User ID obtained by a lookup of the account number determined from the cookie and cross referenced against UC (Authorized User ID); a password field; a table with CJ, CK, CL, and CM (browsing rate and breakaway information); and a submit button. Actuation of the submit button sends a user ID and password to the authorization module 46 (block 112).

Authorization module 46 checks for a match of the user ID and password fields with UC and UD (block 114). If there is no match, the login fails, and it is logged in error log database 66 (block 116). Authorization module 46 may also check login database 68 for all records over a predetermined time frame (e.g., thirty minutes), checking for UA=LC. If the user's current IP address is not in the same Class A subnet as LB, authorization module 46 may deny login (block 116) unless UQ=yes. This prevents multiple people from logging on using the same account unless that feature is authorized.

If the login is approved, the authorization module 46 checks to see if the referring content provider is an adult site (block 118). This may be done by checking CZ for that particular content provider. If the answer to block 118 is yes, the authorization module determines if the user is an adult user by checking UF (block 120). If the answer to block 120 is no, an error message is returned (block 122) and logged in error log database 66. If the answer to block 120 is yes (the user is an adult), or if the answer to block 118 is no (it is not an adult site), then the authorization module 46 determines if the user has sufficient funds to browse (block 124). This may be done by comparing CJ<UH. If the answer is no, then an insufficient funds error message may be displayed and a link spawned to the customer service module 56 where the user may add funds (block 126).

If the answer to block 124 is yes, there are sufficient finds, the authorization module 46 determines if the content provider's web site (secure or otherwise) is administratively up (block 128) as determined by CZ4. If the content provider's web site is administratively down, an error message stating such may be displayed (block 130).

If the answer to block 128 is yes, the site is currently up, the process continues in FIG. 7B, where the authorization module 46 populates AC, AD, AE, and AF in the activity log database 62 with the appropriate user and customer information (block 132). Authorization module 46 creates a random user ID and password that is to be sent to the authentication module 48 (block 134).

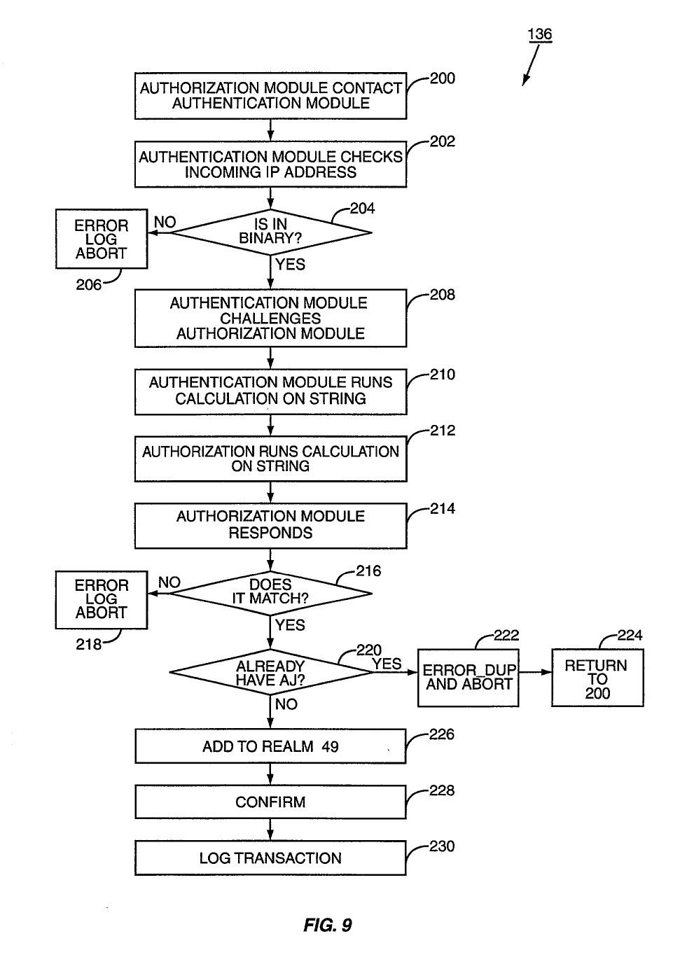

Authorization module 46 opens a connection to the appropriate authentication module 48 via referencing CZ5 and sends a command OPEN and a current_time (block 136). The details of the conversation are presented below with reference to FIG. 9. In short, the two modules verify that each is what it claims to be and authorization module 46 places the randomized user ID and password pair in the authentication module 48 for later use. Assuming that the conversation confirms that the authentication module 48 and the authorization module 46 have satisfied that the other module is who it is supposed to be, the authorization module 46 sets the date/time of open to a current_time in the activity log database 62 (block 138). This may be done by setting AA=current_time. Authorization module 46 sets spent to the browsing rate initial in activity log database 62 (block 140). This maybe done by setting AK=CJ.

Authorization module 46 sets AM user ID/password pair in the activity log database 62 to the randomized pair created during the conversation (block 142). This may be done by populating AJ with the appropriate information.

Authorization module 46 redirects the user's browser to the URL stored in CY with the AM user ID/password pair prepended (block 144). The content provider's web server checks the prepended User ID/password pair against authorized pairs in password realm 49 for a match (not shown explicitly). If there is a match, premium content is provided. If not, an error is generated.

Authorization module 46 determines if the user wishes a user status window (block 146). This may be done by determining if UM is set to yes. If the answer is no, then the user may browse (block 152). If the answer is yes, then the authorization module 46 sets User status window open=yes (block 148). This may be done by changing AH in the activity log 62. Authorization module 46 then spawns a new browser window with the user status window (block 150). The user may then browse the premium content (block 152).

The new account routine is explicated with reference to FIG. 8. As noted above, the user may be routed to the service provider computer 16 from the content provider computer 14. Alternatively, the user may know of the service provider and surf directly to the web page of the service provider. In the event of a referral, the process of FIG. 8 begins when the user is determined not to have a cookie. In the event of a direct surf, the user may select a command such as “open new account” (block 160). It is possible that a referred customer who has a cookie may also select the open new account command as well if they wished to establish separate accounts for different purposes, had discontinued a particular credit card, or for other reason as they saw fit.

In either event, the customer service module 56 is triggered (block 162). If the event was triggered by a referral, the new user account creation page may be a cobranded page (CZ2). Alternatively, the web page may be a generic new user account creation page, but in either event, a new user account creation web page is displayed (block 164). This web page will contain empty fields in which a user may enter information—specifically UA, UB, UC, UD, UE, UF, UK, UM, UN, UO, and UP. Additionally, if the user was a referral, a hidden field may be provided with the identity of the referrer. The user enters the appropriate information (block 166) and submits the data, such as through clicking on a submit command button.

Customer service module 56 creates a new record in the user database 60, populating UA with a sequential number and filling UB, UC, UD, UE, UF, UK, UM, UN, UO, and UP with the data entered by the user (block 168). The user is redirected to another web page in which the user is allowed to purchase bits with some form of payment means such as a credit card, bank account number, or the like (block 170).

In one embodiment, the page that allows the user to purchase bits makes fields UC, UH, and UI not editable, but allows UG (credit card number) to be editable. The field for UG may include a button which allows the information therein to be stored in a secure database along with UA (user account number). Also displayed may be a field ADDAMOUNT, which is the dollar value of the bits purchased, e.g., ten dollars. Another field displayed may be CONVERTEDBITS, which equals the amount in ADDAMOUNT*EA. A button may also factor in any promotional bonus bits according to the following routine.

If ADDAMOUNT≦EH, then CONVERTEDBITS=(ADDAMOUNT*EA)+EC+EE+EG+EI; elseif EF≦ADDAMOUNT<EH, then CONVERTEDBITS=(ADDAMOUNT*EA)+EC+EE+EG; elseif ED≦ADDAMOUNT<EF, then CONVERTEDBITS=(ADDAMOUNT*EA)+EC+EE; EB≦ADDAMOUNT <ED, then CONVERTEDBITS=(ADDAMOUNT*EA)+EC; else CONVERTEDBITS=(ADDAMOUNT*EA).

Upon actuation of the submission, a javascript, or other program, updates the CONVERTEDBITS and triggers the customer service module 56 to request credit card authorization from a third party billing system (VISA, MASTERCARD, etc.). A failed authorization returns an error to the user. If the charge is authorized, the user account is updated and a cookie is stored on the user's browser (block 172). The user is then redirected to the cobranded login page CZ1, effectively sending the user to block 110 on FIG. 7A (block 174).

FIG. 9 illustrates the initial conversation and verification steps between the authorization module 46 and the authentication module 48. This represents an exploded illustration of block 136 in FIG. 7. Authorization module 46 contacts authentication module 48 (block 200). Authentication module 48 checks the incoming IP address against an access list of allowed IP addresses (block 202). This is part of the authentication module 48 binary. If the IP address is not in the access list as determined in block 204, authentication module 48 populates customer-side log 44 with the appropriate entries: GA with the current_time just passed to it, GB with ERROR_IP, GC with the offending IP address and aborts the operation (block 206).

If the answer to block 204 is yes, the IP address is in the binary, authentication module 48 responds to the authorization module 46 with a command: CHALLENGE followed by a random hexadecimal string (block 208). Authentication module 48 also runs a calculation on the random string with a security key hexadecimal value embedded in the authentication module 48 (block 210). This key should match the key in CZ6.

Authorization module 46 runs a calculation on the random string received with CZ6 (block 212). Authorization module 46 responds to the authentication module 48 with the answer to the calculation followed by AJ, the command ADD, and a new current_time (block 214).

Authentication module 48 checks for a valid incoming string (block 216). If the string does not match, the authentication module 48 logs the error, populating GA with the new current_time; GB with ERROR_KEY; and GC with the IP address. Authentication module 48 sends the error to the authorization module 46 and aborts the operation (block 218).

Authentication module 48 checks to see if the user portion of AJ exists in the customer's secure password realm 49 (block 220). If it does exist, authentication module 48 populates customer side log 44 with most recent current_time received from authorization module 46, GB with ERROR_DUP, and GC with the AJ and aborts the transaction (block 222) and forwards the error to the service provider computer 16. Upon receipt of the error, authorization module 46 returns to block 200 (block 224).

If the answer to block 220 is no, AJ is not already in the password realm 49, then the authentication module 48 adds AJ to the password realm 49 (block 226). Authentication module 48 then populates GA, GB, and GC with the appropriate information and sends a confirm message to the authorization module 46 (block 228) and logs the transaction locally in the customer side current activity database 55 (block 230).

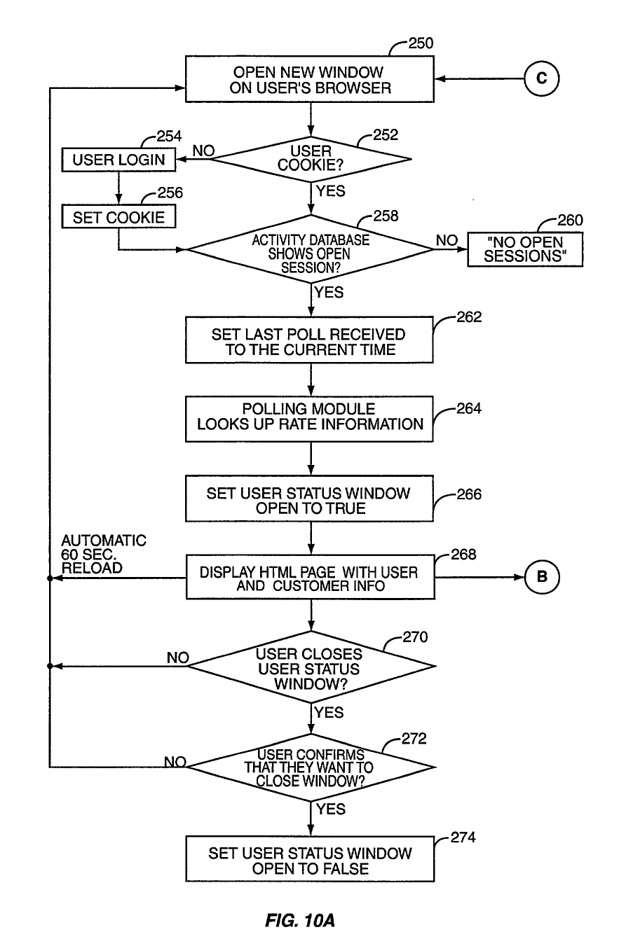

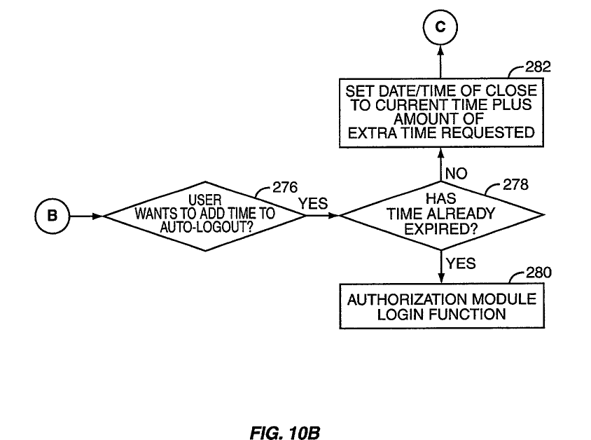

FIGS. 10A and 10B illustrate in a flow chart format the functions of the polling module 52 after a user begins a session of accessing premium content. As noted in FIG. 7, a new window is opened in the user's browser (block 150). Authorization module 46 checks to see if UK (auto logout prej)=yes and sets AB (Date/Time of close)=current_time+UL (auto logout time). The polling module 52 is triggered by the spawning of the new window.

Polling module 52 checks the cookie on the user's browser and matches the value to UA (Account number) (block 252). If the answer is no, there is no cookie, then the user is sent to the user login screen (block 254) and a cookie is passed to the user's browser (block 256). After receipt of the cookie, or if block 252 was answered that there was already a cookie, polling module checks the activity log database 62 to see if there are any open sessions (block 258). This amounts to checking for an entry where AE (customer account number)=UA and AG (Accounted)=false. If there are no matches, then the user is presented with a display that says “you have no open sessions” or the like (block 260) and a link is provided to the customer service web page triggering customer service module 56.

If there is an open session, the polling module 52 sets AI (last poll received)=current_time (block 262). Polling module 52 looks up rate information associated with the session information in the activity database 62 (block 264) and sets AH (user window status window open)=true (block 266). Polling module 52 displays a page (block 268). This web page may include a javascript command that causes the web page to be reloaded every sixty seconds by the polling module 52 so that the process iterates in a timely fashion and alerts the service provider that the user is still reachable.

This web page may include a button that allows the user to close the user status window. Thus, the polling module 52 asks if the user has closed the user status window (block 270). A javascript command may enable this functionality. If the answer is no, the procedure repeats as noted. If the answer is yes, the user has attempted to close the user status window, then the polling module 52 may inquire whether they wish to confirm that they are closing the user status window (block 272). If the user will not confirm closing the user status window, the process repeats as noted. If the user confirms the closing of the user status window, it is closed and the user status window open variable is set to false (block 274).

The web page displayed in block 268 may also have a command that allows the user to add time to the automatic logout time (block 276). If that command is actuated, the polling module 52 may inquire as to whether the time has already expired (block 278). To do this, polling module 52 checks the current_time versus the auto logout time (AB) and any previously added values. If the answer to block 278 is yes, the time has already expired, the authorization module 46 launches the login function again (block 280) and the process begins from there. If the answer to block 278 is no, the time has not expired, then the polling module 52 then sets the date/time of close to current_time plus the amount of extra time requested (block 282) and the process continues as noted.

To effectuate some of the functionality above, the web page may also display variables CB, CJ, CK, CL, CM, AL, AK, AA, AF, and have a hidden AN variable present. The page may also display a link to http://AJ@CY, where AJ and CY are actual values in the activity log database 62 and the customer service database 56.

Polling module 52 may also display the amount left in the account by calculating UH (balance available for spending)−AK (spent). The page may also have a logout command, which links the user back to the authorization module 46 which updates the activity log database 62.

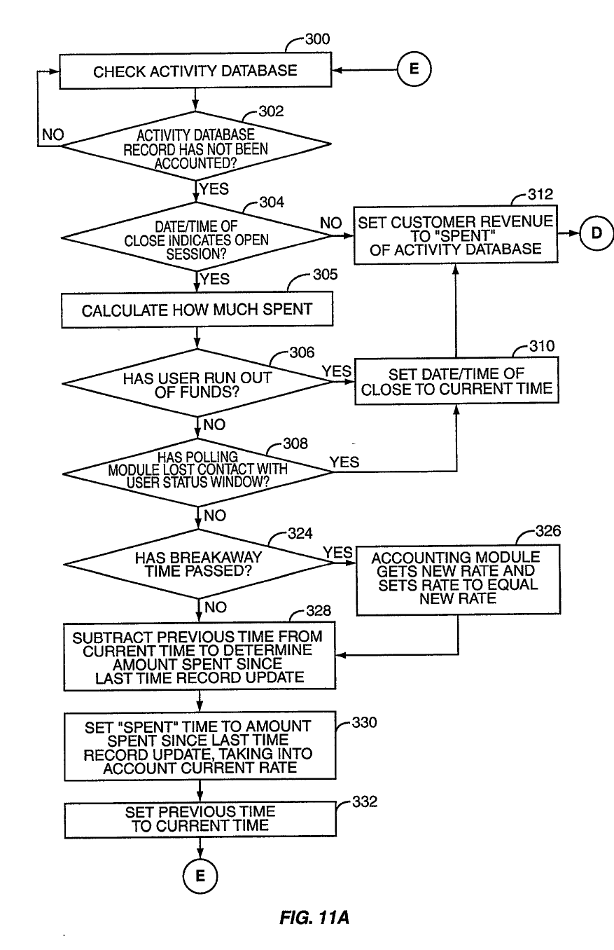

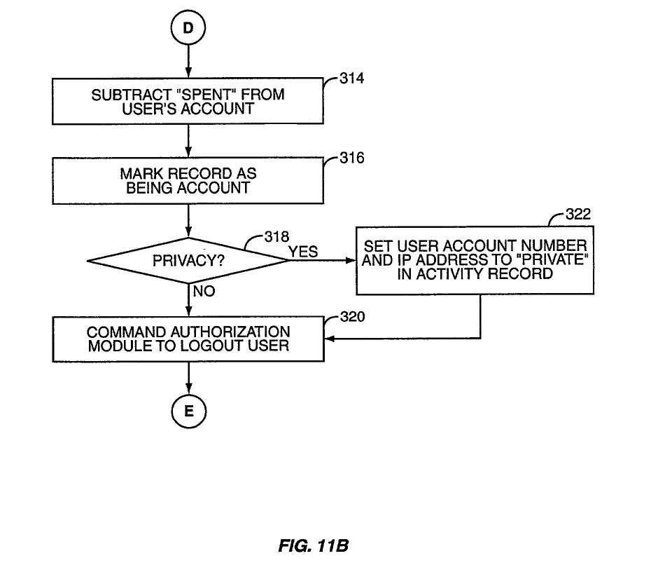

FIGS. 11A and 11B illustrate a flow chart diagram of the function of the 110 accounting module 50. This function takes place during each loop of the accounting module 50 and is not, in the preferred embodiment, triggered by any particular event.

Accounting module 50 checks the activity database 62 records for any records that have not been accounted (block 302). This may be done by determining if AG (Accounted)=false. If the answer is no, then accounting module repeats block 300. If the answer to block 300 is yes, there are records for which accounting has not been done, the accounting module 50 checks the date/time of close of all unaccounted sessions, checking for open sessions (block 304). The answer to block 304 is yes the session is open, the accounting module 50 reads the time the session started and calculates how much time has passed and what has been spent (block 305). Accounting module 50 then determines if the user has run out of funds (block 306). The process may then check if the site is administratively up or down (not shown). If the site is down, then the active accounts may be closed. If the site is up, the process continues. If the answer to block 306 is no, the user has not run out of funds, accounting module 50 determines if the polling module 52 has lost contact with the user status window (block 308). Accounting module 50 may additionally periodically check CZ4 to determine if the content provider is administratively up (not shown explicitly). If the content provider is administratively down, accounting module may set the close time to the current_time so that the session will be closed automatically. Accounting module 50 checks to see if the last refresh of the user status window is more than five minutes old, indicating loss of communication with the user status window. Alternate times may also be used. If either block 306 or block 308 is answered yes, the polling module 50 sets the date/time of close to current_time (block 310). After setting date/time of close to current_time or if block 304 is answered negatively, accounting module 50 sets the customer revenue to the value of spent in the activity database 62 (block 312). Accounting module 50 then subtracts spent from the user's account (block 314) (FIG. 11B) and marks the record as being accounted (block 316). Marking the record as being accounted may comprise setting the variable AG=true. Accounting module 50 then determines if the privacy flag is set (block 318). If the answer to block 318 is no, the accounting module 50 commands authorization module 46 to log out the user. If the answer to block 318 is yes, the privacy is indicated, the accounting module 50 sets user account number and IP address to private activity record 62 (block 322) and commands authorization module 46 to log out the user (block 320). Accounting module 50 then returns to checking the activity database 62 as previously indicated at block 300.

If, however, the answer to block 308 is negative, indicating that the polling module has not lost contact with the user status window, accounting module 50 determines if the break away time has passed (block 324). If the answer to block 324 is yes, accounting module 50 gets the new rate and sets the rate equal to the new rate (block 326). If block 324 is answered negatively or after the new rate has been set, accounting module 50 then subtracts the previous time from current_time to determine an amount of spent since last time record updated (block 328). Set spent to amount spent since last time record updated taking into account the current rate and any change induced by the breakaway (block 330). Accounting module 50 then sets previous time to current_time (block 332).

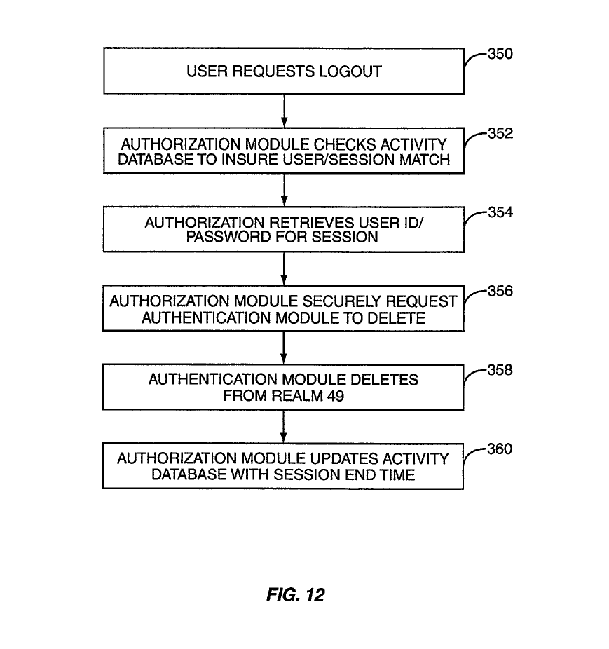

FIG. 12 illustrates a flow chart diagram of one embodiment of the logout function of present invention. This occurs when a user logs out of a customer site after completion of his browsing, triggering of the automatic logout time, or other similar event (block 350). Authorization module 46 checks the activity database 62 to ensure that the user and session match (block 352). Authorization module 46 retrieves the appropriate user ID and password for the session (block 354). Authorization module 46 securely requests that the authentication module 48 delete the user ID and password for the session from the secure password realm 49 (block 356) and the authentication module 48 deletes the pair from the password realm 49 (block 358). Authorization module 46 updates the activity database 62 with the time that the session was closed (block 360).

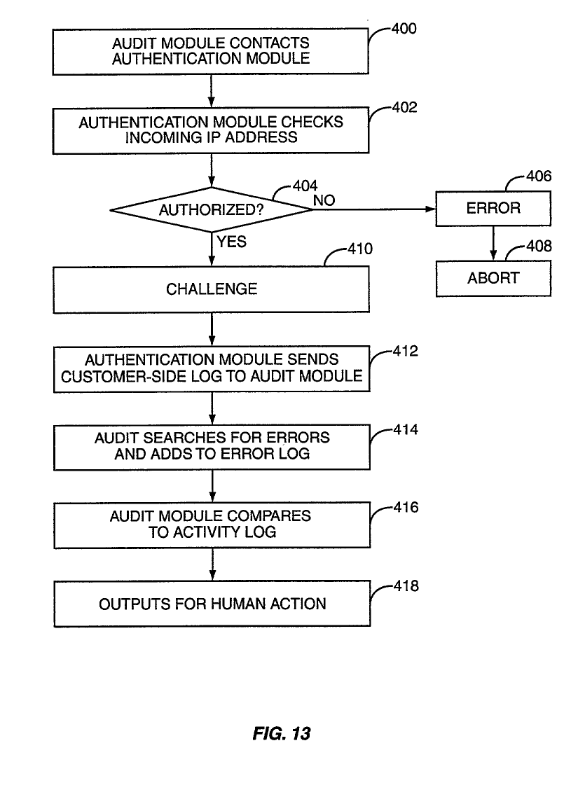

FIG. 13 illustrates one embodiment of the functions of the audit module 54. In one embodiment audit module 54 reiterates once every 12 hours to catch errors within the system. Upon actuation, audit module 54 contacts the authentication module 48 (block 400). In one embodiment this may be done by accessing CZ5 of the particular customer and sending a command OPEN and current_time. Authentication module 48 checks the incoming IP address against a list of authorized IP addresses (block 402). Particularly, the authentication module 48 determines if the incoming IP address is authorized to communicate with the authentication module 48 (block 404). If the incoming IP address is not authorized IP address, an error (block 406) is created and the operation aborts (block 408). If it is authorized then the authentication module 48 can issue a challenge (block 410). This challenge is substantially similar to that discussed with reference to block 408 above. After successful completion of the challenge step authentication module 48 sends customer side log 44 to the audit module 54 (block 412). Audit module 54 searches the customer side log 44 for errors within the customer site log error log and adds these error logs to error log 66 (block 414). Audit module 54 then compares this to the activity log 62 (block 416) and outputs any discrepancies for human action at the appropriate time (block 418).

Specifically, audit module 54 may search the customer site log for ERROR_DUPERROR_KEY, ERROR_IP or ERROR_NO. If audit module 54 finds any of these entries, then module 54 copies the information to new record populating RA with GA, RB with current time, RC with GB and RD with GC. Further audit module 54 in comparing the activity database 62 with the customer side log 44 may search for timestamps within a certain amount of time of the activity log 62 timestamps. This is true for both the add and delete command and any audit commands.

Audit module 54 may also scan the customer database for all instances where CZ4=UP and CZ8>(current_time minus three minutes). For each instance, a connection may be made to CZ5 with a HELLO command and a new current_time. Authentication module 48 checks for a valid incoming IP address. If the address is valid, authentication module 48 may respond with a HELLO command, otherwise it generates an error. Simultaneously, the authentication module 48 may reset its own internal HELLO timer. Audit module 54 may set CZ8 to the new current_time. If there is no contact with the authentication module 48, an error may be created in the error log. If CZ8>(current_time plus fifteen minutes) then CZ4 may be set to down, and an error logged, representing that it has been fifteen minutes since the last contact with the content provider computer 14, providing a clue that the content provider computer 14 is administratively down.

Authentication module 48 may include a HELLO counter, alluded to above, that when it reaches fifteen minutes without being reset, deletes all user password pairs contained in the customer-side activity database located on the content provider computer 14.

While it is expected that TCP/IP will be used for all connections, this is not strictly required by the present invention. In fact, the present invention is well suited for user with Ipv6, not yet implemented.

Note that while it is contemplated that software is the most economical way to implement the present invention, enterprising individuals may also embody the functionality of the present invention in dedicated circuitry that performs identically without the need for software per se. Such alternate structures are still within the scope of the present invention.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of securing payment for access to content comprising:
receiving a request from a user for restricted access content;
redirecting the user to a service provider for authentication;
receiving from the service provider indicia relating to authorization privileges;
accepting login information from the user, said login information related to said indicia relating to authorization privileges;
providing access to content to the user; and
receiving payment from the service provider based on time spent by the user accessing the content.

2. The method of claim wherein receiving from the service provider indicia relating to authorization privileges comprises receiving a user ID and password pair from the service provider.

3. The method of claim 1 further comprising providing an error log to the service provider.

4. The method of claim 1 further comprising challenging the service provider prior to receiving indicia relating to authorization privileges.

5. The method of claim 4 wherein said challenging comprises a secure key exchange.

6. The method of claim 4 further comprising receiving an answer from the service provider in response to said challenging.

7. The method of claim 6 further comprising generating an error message if receiving an answer results in an improper answer being received from the service provider.

8. The method of claim 1 further comprising communicating with an audit module at the service provider.

9. The method of claim 8 wherein communicating with an audit module comprises using TCP to communicate with the audit module.

10. The method of claim 1 further comprising ignoring incoming messages from IP addresses other than a set of predetermined authorized IP addresses.

11. A method of securing payment for access to content comprising:
receiving a redirected user from a content provider;
accounting with the redirected user;
providing the user with login information;
providing to the content provider indicia relating to authorization privileges;
sending the user to the content provider;
tracking time spent by the user accessing premium content; and
accounting with the content provider for time spent by the user accessing the premium content.

12. The method of claim 11 wherein accounting with the redirected user comprises accepting payment from the redirected user and establishing a credit against which the redirected user may draw.

13. The method of claim 12 wherein accounting with the redirected user comprises adding value to an amount available for spending based on said accepting payment.

14. The method of claim 11 wherein providing to the content provider indicia relating to authorization privileges comprising generating a random user ID and password pair and sending the user ID and password pair to the content provider.

15. The method of claim 11 further comprising responding to a challenge from the content provider prior to providing to the content provider indicia relating to authorization privileges.

16. The method of claim 15 wherein responding to a challenge comprises performing a calculation on a string provided from the content provider with a secure key and returning a result from the calculation to the content provider.

17. The method of claim 11 further comprising receiving information related to errors tracked at the content provider.

18. The method of claim 11 further comprising auditing the content provider's records to determine the existence of errors.

19. The method of claim 11 wherein tracking time spent by the user accessing premium content comprises counting down to an automatic logout time associated with the redirected user.

20. The method of claim 19 further comprising allowing the redirected user to add time to the automatic logout time.

21. A system for securing payment for access to content comprising:
means for receiving a redirected user from a content provider;
means for accounting with the redirected user;
means for providing the user with login information;
means for providing to the content provider indicia relating to authorization privileges;
means for sending the user to the content provider;
means for tracking time spent by the user accessing premium content; and
means for accounting with the content provider for time spent by the user accessing the premium content, all of said means being at least partially implemented on a computer.

22. The system of claim 21 wherein said means comprise software implemented on a computer.

23. A method of communicating between a content provider and a service provider comprising:
establishing an authorization module at the service provider;
establishing an authentication module at the content provider;
passing a user ID and password from the authorization module to the authentication module, wherein the user ID and password allow a user to access premium content at the content provider;
tracking, at the service provider, time spent by users accessing the premium content at the content provider; and
accounting to the content provider for that access.

24. The method of claim 23 further comprising listening, with the authentication module, for communication from the authorization module.

25. The method of claim 23 wherein listening comprises listening using TCP.

26. The method of claim 23 further comprising gating, at the authentication module, incoming communication.

27. The method of claim 26 wherein gating incoming communication comprises accepting incoming communication only from predetermined authorized IP addresses.

28. The method of claim 27 further comprising ignoring incoming communication from IP addresses other than the predetermined authorized IP addresses.

29. The method of claim 23 further comprising verifying that said authorization module is in periodic communication with said authentication module.

30. The method of claim 23 further comprising verifying incoming messages from the authorization module.

31. The method of claim 30 wherein verifying incoming messages from the authorization module comprises issuing, at the authentication module a challenge followed by a random hexadecimal string.

32. The method of claim 31 further comprising performing a calculation on the random hexadecimal string at the authentication module.

33. The method of claim 32 further comprising receiving, at the authorization module, the challenge and the random hexadecimal string.

34. The method of claim 33 further comprising, performing a calculation, at the authorization module, a calculation on the random hexadecimal string with a secure key.

35. The method of claim 34 further comprising responding, from the authorization module, to the challenge with the results of the calculation performed at the authorization module, an add command, and a random user ID and password pair.

36. The method of claim 35 further comprising checking the results of the calculation performed at the authorization module with the results of the calculation performed at the authentication module.

37. The method of claim 36 further comprising generating an error message if the checking does not result in a match.

38. The method of claim 23 further comprising generating a user and password database at the content provider.

39. The method of claim 38 further comprising searching the database with the authentication module.

40. The method of claim 38 further comprising adding items to the database with the authentication module.

41. The method of claim 38 further comprising deleting items from the database with the authentication module.

42. The method of claim 23 further comprising auditing information at the authentication module with an audit module.

43. The method of claim 42 wherein auditing information at the authentication module comprises comparing the information at the authentication module to an activity log at the service provider for discrepancies.

44. The method of claim 23 further comprising polling the user with a polling module to determine if the user is online.

45. The method of claim 44 wherein polling the user comprises polling the user through scheduled communication.

46. The method of claim 44 further comprising detecting when the user is idle.

47. The method of claim 44 further comprising detecting when the user is no longer visiting premium content.

48. The method of claim 44 further comprising providing a user status window to the user.

49. The method of claim 48 further comprising detecting when the user closes the user status window.

50. The method of claim 48 further comprising, displaying, in the user status window, a current cost to the user.

51. The method of claim 50 further comprising changing the current cost value displayed to the user.

52. The method of claim 48 further comprising displaying, in the user status window, a value associated with how much the user has spent accessing the premium content.

53. The method of claim 48 further comprising, displaying, in the user status window, time left until auto-logout.

54. The method of claim 53 further comprising allowing the user to extend the time left until auto-logout.

55. The method of claim 48 further comprising displaying, in the user status window, an amount of funds that the user has left to spend.

56. The method of claim 48 further comprising displaying, in the user status window, a site or sites for which the user is currently paying for access thereto.

57. The method of claim 56 wherein displaying a site or sites comprises displaying a URL or URLs for the sites.

58. The method of claim 23 further comprising accounting between the service provider and the content provider.

59. The method of claim 58 further comprising using an accounting module to determine open sessions through an inquiry to an activity database.

60. The method of claim 58 further comprising using an accounting module to determine closed sessions through an inquiry to an activity database.

61. The method of claim 59 further comprising determining, with the accounting module, current rates in the activity database.

62. The method of claim 61 further comprising adjusting current rates in the activity database.

63. The method of claim 58 further comprising calculating, with the accounting module an amount a user has spent in a given session.

64. The method of claim 63 further comprising sending a command to terminate an open session if the amount a user has spent equals an available balance for spending associated with that user.

65. A method of controlling access to premium content at a content provider, comprising:
communicating between a service provider and the content provider;
establishing a user account with the service provider; and
placing entries in a user and password database on the content provider, the user and password entries created at the service provider.

66. The method of claim 65 further comprising removing entries in the user and password database after expiration of a predetermined amount of time.

67. The method of claim 65 further comprising tracking the communicating to verify that the service provider and the content provider maintain a communications link.

68. The method of claim 67 further comprising removing entries in the user and password database in the communication link fails.

69. A method of controlling access to premium content at a content provider, comprising:
communicating between a service provider and the content provider;
establishing a user account with the service provider;
tracking access to the premium content in a user status window; and
charging the user only so long as the user status window remains in communication with the service provider.

70. A method of controlling access to premium content at a content provider, comprising:
communicating between a service provider and the content provider;
establishing a user account with the service provider; and
placing entries in a user and password database on the content provider, the user and password entries created at the service provider, said entries valid only as long as the service provider and content provider are communicating.

71. The method of claim 70 further comprising removing said entries when the service provider and content provider are no longer communicating.

72. The method of claim 71 further comprising determining if the service provider and content provider are communicating by referencing a customer side current activity database.

73. A method of controlling access to premium content at a content provider, comprising:
establishing sessions wherein a user accesses the premium content at the content provider;
identifying open sessions;
calculating an amount spent by the user as the user accesses the premium content; and
insuring that the user still has funds available for spending at a service provider.
